(19) United States
(12) Patent Application Publication
(10) Pub. No.: US 2026/0127069 A1
(43) Pub. Date: May 7, 2026

(54) DECODING DEVICE AND METHOD FOR PERFORMING MOST RELIABLE BASIS-LIKE DECODING

(71) Applicant: HUAWEI TECHNOLOGIES CO., LTD., Shenzhen (CN)

(72) Inventor: Marc FOSSORIER, Munich (DE)

(21) Appl. No.: 19/440,769

(22) Filed: Jan. 6, 2026

Related U.S. Application Data
(63) Continuation of application No. PCT/EP2023/068895, filed on Jul. 7, 2023.

(51) Int. Cl. G06F 11/10

(52) U.S. Cl. CPC G06F 11/10

(57) ABSTRACT

A decoding device for performing most reliable basis-like (MRB-like) decoding of a code having length N and dimension K and method are provided. The decoding device is configured to receive a sequence of one or more channel observations. Then, the decoding device orders one or more reliability values in a decreasing order, each reliability value corresponding to the channel observations of the received sequence. The decoding device determines an MRB-like basis of the code based on the ordered reliability values. The MRB-like basis is defined by K independent positions that are obtained from the ordering. The decoding device further constructs a generator matrix from an ordering determined by the MRB-like basis using Gaussian elimination performed on a submatrix of a first matrix. The first matrix is derived from a reduced echelon form generator matrix of the code. Then, the decoding device performs decoding based on the constructed generator matrix.

### CROSS-REFERENCE TO RELATED APPLICATIONS

This application is a continuation of International Application No. PCT/EP2023/068895, filed on Jul. 7, 2023, the disclosure of which is hereby incorporated by reference in its entirety.

### TECHNICAL FIELD

The present disclosure relates to a decoding device for performing most reliable basis-like (MRB-like) decoding. The disclosure further provides a method for performing MRB-like decoding and a computer program product to perform the method.

### BACKGROUND

Some conventional decoders of linear block codes depend on the particular code considered and become code dedicated, while others are universal and can be applied to a large class of codes.

Current universal decoders are developed in conjunction with the most reliable basis (MRB) that is defined as the set of the most reliable independent positions (MRIPs) thus forming an information set. The existing MRB-based universal decoders may have a large computational complexity, which limits the role of the universal decoders in the current standards.

Moreover, current MRB-based universal decoders rely on Gaussian elimination (GE) to put the generator matrix of the code considered into systematic form with respect to the MRB for encoding the MRIPs. Such a GE operation adds a significant computational complexity to the decoder. For a (N, K) linear block code, the complexity of GE is O (N min {K, N−K}²).

### SUMMARY

In view of the above, this disclosure aims to improve conventional MRB-based decoders. An objective is to provide a MRB-based universal decoder for all linear block codes that has a significantly lower computational complexity and that provides the same decoding performance.

This and other objectives are achieved by the solutions of this disclosure as described in the independent claims. Advantageous implementations are further defined in the dependent claims.

According to a first aspect, a decoding device for performing MRB-like decoding of a code having length N and dimension K is provided. The decoding device is configured to: receive a sequence y of one or more channel observations; order one or more reliability values in a decreasing order, each reliability value corresponding to the channel observations of the received sequence y; determine a MRB-like basis of the code based on the ordered reliability values, where the MRB-like basis is defined by K independent positions that are obtained from the ordering; construct a generator matrix from an ordering determined by the MRB-like basis using GE performed on a submatrix of a first matrix, the first matrix being derived from a reduced echelon form generator matrix of the code; and perform decoding based on the constructed generator matrix.

The MRB-like basis may not be exactly the same as the MRB; however, a discrepancy between them is small.

This enables to separate most of the information positions from the parity positions of the original representation of the code based on the ordering owing to the MRB-like basis. As a result, the original information positions in the MRB-like basis do not need to be considered by the GE, that is, a full GE may not be needed and only a restricted GE can be performed. The decoding process can be modified accordingly, if needed. This enables a significant reduction in the computational complexity.

In this disclosure, restricted GE refers to performing GE only in matrix with a size smaller than the full size of a generator matrix of the code.

In an implementation form of the first aspect the submatrix defines at most K information positions of the code.

In an implementation form of the first aspect, determining the MRB-like basis of the code based on the ordered reliability values comprises: defining a first permutation function λ₁ as the ordered reliability values; and constructing the first matrix G₁ based on the ordered reliability values and based on a generator matrix of the code.

In an implementation form of the first aspect, constructing the first matrix G₁ based on the ordered reliability values and based on the generator matrix of the code comprises: obtaining the first matrix G₁ by applying the first permutation function λ₁ to a matrix G_{REF} as λ₁ (G_{REF}), where the matrix G_{REF} is the reduced echelon form generator matrix of the code, and where K columns of G_{REF} are related to information positions of the code and one or more N−K columns of G_{REF} are related to parity positions of the code; and performing one or more permutations in the first matrix G₁.

Performing one or more permutations in the first matrix G₁ comprises performing one or more column permutations to bring |B_{K,MR}| columns of the first matrix G₁ to first |B_{K,MR}| positions, and performing one or more row permutations to form an identity matrix in the first |B_{K,MR}| positions, where |B_{K,MR}| is a cardinality of a set of indices B_{K,MR}, the set of indices B_{K,MR} comprising a set of indices of the information positions in G_{REF} that belongs to a set of the K most reliable positions.

Further, the performing one or more permutations in the first matrix G₁ comprises performing one or more column permutations to bring |B_{K,LR}| columns of the first matrix G₁ to bring first |B_{K,LR}| positions in last N−K positions, and performing one or more row permutations to form an identity matrix in the first |B_{K,LR}| positions, wherein |B_{K,LR}| is a cardinality of a set of indices |B_{K,LR}|, the set of indices |B_{K,LR}| being a set of indices of the information positions in G_{REF} that belongs to a set of the N−K least reliable positions.

In an implementation form of the first aspect, constructing the generator matrix from the ordering determined by the MRB-like basis using GE performed on the submatrix of the first matrix comprises: obtaining a second matrix

$${G}_{1}^{2}$$

by performing GE on a submatrix of the first G₁; defining a second permutation function λ₂ by performing one or more column permutations on the second matrix

$${G}_{1}^{2}$$

to bring |B_{K,LR}| columns of

$${G}_{1}^{2}$$

to first |B_{K,LR}| positions, and performing one or more row permutations on

$${G}_{1}^{2}$$

to form an identity matrix in the first |B_{K,LR}| positions; and constructing the generator matrix as the permuted second matrix

$${G}_{1}^{2} .$$

In an implementation form of the first aspect, the first submatrix comprises a K×(|B_{K,LR}|+N−K) submatrix of the first matrix G₁ and the constructed generator matrix is a matrix G₂.

Alternatively, the first submatrix comprises a |B_{K,LR}|×(|B_{K,LR}|+N−K) submatrix of the first matrix G₁ and the constructed generator matrix is a matrix

$${G}_{2}^{′} .$$

By performing GE in a submatrix of the first matrix, the restricted version of GE is achieved, which has less computational complexity compared to the conventional GE.

In an implementation form of the first aspect, performing decoding based on the constructed generator matrix comprises: constructing one or more error vectors; determining one or more codewords based on the constructed generator matrix and based on the one or more error vectors; and estimating a message based on the determined one or more codewords and based on a decision rule.

Thereby, decoding can be implemented by using the generator matrix obtained by the restricted GE.

When the GE is performed in the K×(|B_{K,LR}|+N−K) submatrix of the first matrix G₁, decoding can be performed in a conventional manner using the resulting generator matrix G₂.

When the GE is performed in the |B_{K,LR}|×(|B_{K,LR}|+N−K) submatrix of the first matrix G₁, the decoding process may be modified according to the constructed generator matrix

$${G}_{2}^{′} .$$

In an implementation form of the first aspect, constructing the one or more error vectors comprises: determining an ordered received sequence of channel observations

$${y}^{′} = ( {y}_{0}^{′} , {y}_{1}^{′} , … , {y}_{N - 1}^{′} )$$

corresponding to the generator matrix of the code

$${G}_{2}^{′} ,$$

where

$${y}_{i}^{′}$$

with i=0, 1, . . . , N−1 denotes an i-th element of the ordered sequence y′; determining a hard decision decoding

$${z}^{′} = ( {z}_{0}^{′} , {z}_{1}^{′} , … , {z}_{N - 1}^{′} )$$

corresponding to the ordered received sequence y′, where

$${z}_{i}^{′}$$

with i=0, 1, . . . , N−1 denotes an i-th element of the hard decision decoding z′; and creating a list of candidates [symbol] of a transmitted message comprising one or more elements j, wherein each element j is obtained by adding a respective error vector

$${e}_{j}^{′} = ( {e}_{j , 0}^{′} , {e}_{j , 1}^{′} , … , {e}_{j , K - 1}^{′} )$$

to a vector

$${z}_{K}^{′} = ( {z}_{0}^{′} , {z}_{1}^{′} , … , {z}_{K - 1}^{′} ) ,$$

where

$${e}_{j , i}^{′}$$

with i=0, 1, . . . , K−1 denotes an i-th element of a respective j-th error vector

$${e}_{j}^{′} .$$

In an implementation form of the first aspect, each error vector is constructed based on a corresponding decreasing likelihood. Alternatively, each error vector is constructed in a deterministic order within one or more families of increasing Hamming weigh.

In an implementation form of the first aspect, determining the one or more codewords based on the constructed generator matrix and based on the one or more error patterns comprises: determining an order-zero codeword

$${c}_{0}^{′}$$

for the vector

$${z}_{K}^{′} = ( {z}_{0}^{′} , {z}_{1}^{′} , … , {z}_{K - 1}^{′} )$$

based on the constructed generator matrix

$${G}_{2}^{′} ;$$

and determining a codeword

$${c}_{j}^{′}$$

for each of a respective j-th error vector

$${e}_{j}^{′}$$

in the list [symbol] based on the calculated order-zero codeword

$${c}_{0}^{′}$$

and based on the constructed generator matrix

$${G}_{2}^{′} .$$

In an implementation form of the first aspect, determining the order-zero codeword

$${c}_{0}^{′}$$

for the vector

$${z}_{K}^{′} = ( {z}_{0}^{′} , {z}_{1}^{′} , … , {z}_{K - 1}^{′} )$$

based on the constructed generator matrix

$${G}_{2}^{′}$$

comprises: decomposing

$${z}_{K}^{′}$$

based on

$${G}_{2}^{′} as {z}_{K}^{′} = ( \begin{matrix}{z}_{K , MR}^{′} & {z}_{K , LR}^{′}\end{matrix} ) , with {z}_{K , MR}^{′} = ( {z}_{0}^{′} , {z}_{1}^{′} , ... , {z}_{\vert {B}_{K , MR} \vert - 1}^{′} ) and \\ {z}_{K , LR}^{′} = ( {z}_{\vert {B}_{K , MR} \vert}^{′} , {z}_{\vert {B}_{K , MR} \vert + 1}^{′} , ... , {z}_{K - 1}^{′} ) ;$$

and calculating the order-zero codeword as

$${c}_{0}^{′} = {c}_{MR}^{′} + {c}_{LR}^{′} , where {c}_{MR}^{′}$$

is determined based on a product of

$${z}_{K , MR}^{′}$$

and |B_{K,MR}| rows of

$${G}_{2}^{′}$$

and where

$${c}_{LR}^{′}$$

is determined based on a product of

$${z}_{K , LR}^{′}$$

and the remaining |B_{K,LR}| rows of

$${G}_{2}^{′} .$$

In an implementation form of the first aspect, determining the codeword

$${c}_{j}^{′} ,$$

for each of the respective j-th error vector

$${e}_{j}^{′}$$

in the list [symbol] , based on the calculated order-zero codeword

$${c}_{0}^{′}$$

and based on the calculated generator matrix

$${G}_{2}^{′}$$

comprises: decomposing the j-th error vector

$${e}_{j}^{′}$$

in the list [symbol] based on

$${G}_{2}^{′} as {e}_{j}^{′} = ( \begin{matrix}{e}_{j , K , MR}^{′} & {e}_{j , K , LR}^{′}\end{matrix} ) with$$

$${e}_{j , K , MR}^{′} = ( {e}_{j , 0}^{′} , {e}_{j , 1}^{′} , ... , {e}_{j , \vert {B}_{K , MR} \vert - 1}^{′} ) and$$

$${e}_{j , K , LR}^{′} = ( {e}_{j , \vert {B}_{K , MR} \vert}^{′} , {e}_{j , \vert {B}_{K , MR} \vert + 1}^{′} , ... , {e}_{j , K - 1}^{′} ) ;$$

and calculating the respective codeword

$${c}_{j}^{′}$$

for the j-th error vector

$${e}_{j}^{′} as {c}_{j}^{′} = {c}_{0}^{′} + {e}_{j , MR}^{′} + {e}_{j , LR}^{′} ,$$

where

$${e}_{j , MR}^{′}$$

is determined based on a product of

$${e}_{j , K , MR}^{′}$$

and |B_{K,MR}| rows of

$${G}_{2}^{′} ,$$

and where

$${e}_{j , LR}^{′}$$

is determined based on a product of

$${e}_{j , K , LR}^{′}$$

and the remaining |B_{K,LR}| rows of

$${G}_{2}^{′} .$$

In an implementation form of the first aspect, estimating the message based on the determined one or more codewords comprises choosing a j-th candidate message in the list [symbol] having a maximum likelihood decision. The maximum likelihood decision is defined as

$$j = arg max P ( {c}_{j}^{′} \vert y ) ,$$

where

$$P ( {c}_{j}^{′} \vert y )$$

denotes a probability of transmitting the codeword

$${c}_{j}^{′}$$

give the received sequence y.

In an implementation form of the first aspect, the constructed generator matrix comprises a parity matrix in a dual space of the code.

In the dual space of the code, the original parity positions do not need to be considered by the GE. The restricted GE performed in the dual space of the code, thus, may provide with a generator matrix that is a parity matrix in said dual space.

According to a second aspect, a method for performing most reliable basis-like, MRB-like, decoding of a code having length N and dimension K is provided. The method comprises: receiving a sequence y of one or more channel observations; ordering one or more reliability values in a decreasing order, each reliability value corresponding to one of the channel observations of the received sequence y, determining a MRB-like basis of the code based on the ordered reliability values, wherein the MRB-like basis is defined by K independent positions that are obtained from the ordering; constructing a generator matrix from an ordering determined by the MRB-like basis using GE performed on a submatrix of a first matrix, the first matrix being derived from a reduced echelon form generator matrix of the code; and performing decoding based on the constructed generator matrix.

The MRB-like basis may not be exactly the same as the MRB; however, a discrepancy between them is small.

This enables to separate most of the information positions from the parity positions of the original representation of the code based on the ordering owing to the MRB-like basis. As a result, the original information positions in the MRB-like basis do not need to be considered by the GE, that is, a full GE may not be needed and only a restricted GE can be performed. The decoding process can be modified accordingly, if needed. This enables a significant reduction in the computational complexity.

In an implementation form of the second aspect, the submatrix defines at most K information positions of the code.

In an implementation form of the second aspect, determining the MRB-like basis of the code based on the ordered reliability values comprises: defining a first permutation function λ₁ as the ordered reliability values; and constructing the first matrix G₁ based on the ordered reliability values and based on a generator matrix of the code.

In an implementation form of the second aspect, constructing the first matrix G₁ based on the ordered reliability values and based on the generator matrix of the code comprises: obtaining the first matrix G₁ by applying the first permutation function λ₁ to a matrix G_{REF} as λ₁(G_{REF}), where the matrix G_{REF} is the reduced echelon form generator matrix of the code, and where K columns of G_{REF} are related to information positions of the code and one or more N−K columns of G_{REF} are related to parity positions of the code; and performing one or more permutations in the first matrix G₁.

Performing one or more permutations in the first matrix G₁ comprises performing one or more column permutations to bring |B_{K,MR}| columns of the first matrix G₁ to first |B_{K,MR}| positions, and performing one or more row permutations to form an identity matrix in the first |B_{K,MR}| positions, where |B_{K,MR}| is a cardinality of a set of indices B_{K,MR}, the set of indices B_{K,MR} comprising a set of indices of the information positions in G_{REF} that belongs to a set of the K most reliable positions.

Further, the performing one or more permutations in the first matrix G₁ comprises performing one or more column permutations to bring |B_{K,LR}| columns of the first matrix G₁ to bring first |B_{K,LR}| positions in last N−K positions, and performing one or more row permutations to form an identity matrix in the first |B_{K,LR}| positions, wherein |B_{K,LR}| is a cardinality of a set of indices |B_{K,LR}|, the set of indices |B_{K,LR}| being a set of indices of the information positions in G_{REF} that belongs to a set of the N−K least reliable positions.

In an implementation form of the second aspect, constructing the generator matrix from the ordering determined by the MRB-like basis using GE performed on the submatrix of the first matrix comprises: obtaining a second matrix

$${G}_{1}^{2}$$

by performing Gb on a submatrix of the first matrix G₁; defining a second permutation function λ₂ by performing one or more column permutations on the second matrix

$${G}_{1}^{2}$$

to bring |B_{K,LR}| columns of

$${G}_{1}^{2}$$

to first |B_{K,LR}| positions, and performing one or more row permutations on

$${G}_{1}^{2}$$

to form an identity matrix in the first |B_{K,LR}| positions; and constructing the generator matrix as the permuted second

$${G}_{1}^{2} .$$

In an implementation form of the second aspect, the first submatrix comprises a K×(|B_{K,LR}|+N−K) submatrix of the first matrix G₁ and the constructed generator matrix is a matrix G₂.

Alternatively, the first submatrix comprises a |B_{K,LR}|×(|B_{K,LR}|+N−K) submatrix of the first matrix G₁ and the constructed generator matrix is a matrix

$${G}_{2}^{′} .$$

By performing GE in a submatrix of the first matrix, the restricted version of GE is achieved, which has less computational complexity compared to the conventional GE.

In an implementation form of the second aspect, performing decoding based on the constructed generator matrix comprises: constructing one or more error vectors; determining one or more codewords based on the constructed generator matrix and based on the one or more error vectors; and estimating a message based on the determined one or more codewords and based on a decision rule.

Thereby, decoding can be implemented by using the generator matrix obtained by the restricted GE.

When the GE is performed in the K×(|B_{K,LR}|+N−K) submatrix of the first matrix G₁, decoding can be performed in a conventional manner using the resulting generator matrix G₂.

When the GE is performed in the |B_{K,LR}|×(|B_{K,LR}|+N−K) submatrix of the first matrix G₁, the decoding process may be modified according to the constructed generator matrix

$${G}_{2}^{′} .$$

In an implementation form of the second aspect, constructing the one or more error vectors comprises: determining an ordered received sequence of channel observations

$${y}^{′} = ( {y}_{0}^{′} , {y}_{1}^{′} , … , {y}_{N - 1}^{′} )$$

corresponding to the generator matrix of the code

$${G}_{2}^{′} ,$$

where

$${y}_{i}^{′}$$

with i=0, 1, . . . , N−1 denotes an i-th element of the ordered sequence y′; determining a hard decision decoding

$${z}^{′} = ( {z}_{0}^{′} , {z}_{1}^{′} , … , {z}_{N - 1}^{′} )$$

corresponding to the ordered received sequence y′, where

$${z}_{i}^{′}$$

with i=0, 1, . . . , N−1 denotes an i-th element of the hard decision decoding z′; and creating a list of candidates [symbol] of a transmitted message comprising one or more elements j, wherein each element j is obtained by adding a respective error vector

$${e}_{j}^{′} = ( {e}_{j , 0}^{′} , {e}_{j , 1}^{′} , … , {e}_{j , K - 1}^{′} )$$

to a vector

$${z}_{K}^{′} = ( {z}_{0}^{′} , {z}_{1}^{′} , … , {z}_{K - 1}^{′} )$$

where

$${e}_{j , i}^{′}$$

with i=0, 1, . . . , K−1 denotes an i-th element of a respective j-th error vector

$${e}_{j}^{′} .$$

In an implementation form of the second aspect, each error vector is constructed based on a corresponding decreasing likelihood. Alternatively, each error vector is constructed in a deterministic order within one or more families of increasing Hamming weigh.

In an implementation form of the second aspect, determining the one or more codewords based on the constructed generator matrix and based on the one or more error patterns comprises: determining an order-zero codeword

$${c}_{0}^{′}$$

for the vector

$${z}_{K}^{′} = ( {z}_{0}^{′} , {z}_{1}^{′} , … , {z}_{K - 1}^{′} )$$

based on the constructed generator matrix

$${G}_{2}^{′} ;$$

and determining a codeword

$${c}_{j}^{′}$$

for each of a respective j-th error vector

$${e}_{j}^{′}$$

in the list [symbol] , based on the calculated order-zero codeword

$${c}_{0}^{′}$$

and based on the constructed generator matrix

$${G}_{2}^{′} .$$

In an implementation form of the second aspect, determining the order-zero codeword

$${c}_{0}^{′}$$

for the vector

$${z}_{K}^{′} = ( {z}_{0}^{′} , {z}_{1}^{′} , … , {z}_{K - 1}^{′} )$$

based on the constructed generator matrix

$${G}_{2}^{′}$$

comprises decomposing

$${z}_{K}^{′}$$

based on

$${G}_{2}^{′} as {z}_{K}^{′} = ( \begin{matrix}{z}_{K , MR}^{′} & {z}_{K , LR}^{′}\end{matrix} ) ,$$

with

$${z}_{K , MR}^{′} = ( {z}_{0}^{′} , {z}_{1}^{′} , … , {z}_{\vert {B}_{K , MR} \vert - 1}^{′} )$$

and

$${z}_{K , LR}^{′} = ( {z}_{\vert {B}_{K , MR} \vert}^{′} , {z}_{\vert {B}_{K , MR} \vert + 1}^{′} , ... , {z}_{K - 1}^{′} ) ;$$

and calculating the order-zero codeword as

$${c}_{0}^{′} = {c}_{MR}^{′} + {c}_{LR}^{′} ,$$

where

$${c}_{MR}^{′}$$

is determined based on a product of

$${z}_{K , MR}^{′}$$

and |B_{K,MR}| rows of

$${G}_{2}^{′}$$

and where

$${c}_{LR}^{′}$$

is determined based on a product of

$${z}_{K , LR}^{′}$$

and the remaining |B_{K,LR}| rows of

$${G}_{2}^{′} .$$

In an implementation form of the second aspect, determining the codeword

$${c}_{j}^{′} ,$$

for each of the respective j-th error vector

$${e}_{j}^{′}$$

in the list [symbol] , based on the calculated order-zero codeword

$${c}_{0}^{′}$$

and based on the calculated generator matrix

$${G}_{2}^{′}$$

comprises: decomposing the j-th error vector

$${e}_{j}^{′}$$

in the list [symbol] based on

$${G}_{2}^{′} as {e}_{j}^{′} = ( \begin{matrix}{e}_{j , K , MR}^{′} & {e}_{j , K , LR}^{′}\end{matrix} )$$

with

$${e}_{j , K , MR}^{′} = ( {e}_{j , 0}^{′} , {e}_{j , 1}^{′} , … , {e}_{j , \vert {B}_{K , MR} \vert - 1}^{′} ) and$$

$${e}_{j , K , LR}^{′} = ( {e}_{j , \vert {B}_{K , MR} \vert}^{′} , {e}_{j , \vert {B}_{K , MR} \vert + 1}^{′} , … , {e}_{j , K - 1}^{′} ) ;$$

and calculating the respective codeword

$${c}_{j}^{′}$$

for the j-th error vector

$${e}_{j}^{′}$$

as

$${c}_{j}^{′} = {c}_{0}^{′} + {e}_{j , MR}^{′} + {e}_{j , LR}^{′} ,$$

where

$${e}_{j , MR}^{′}$$

is determined based on a product of

$${e}_{j , K , MR}^{′}$$

and |B_{K,MR}| rows of

$${G}_{2}^{′} ,$$

and where

$${e}_{j , LR}^{′}$$

is determined based on a product of

$${e}_{j , K , LR}^{′}$$

and the remaining |B_{K,LR}| rows of

$${G}_{2}^{′} .$$

In an implementation form of the second aspect, estimating the message based on the determined one or more codewords comprises choosing a j-th candidate message in the list [symbol] having a maximum likelihood decision. The maximum likelihood decision is defined as

$$j = arg max P ( {c}_{j}^{′} \vert y ) , where P ( {c}_{j}^{′} \vert y )$$

denotes a probability of transmitting the codeword

$${c}_{j}^{′}$$

given the received sequence y.

In an implementation form of the second aspect, the constructed generator matrix comprises a parity matrix in a dual space of the code.

In the dual space of the code, the original parity positions do not need to be considered by the GE.

The restricted GE performed in the dual space of the code, thus, may provide with a generator matrix that is a parity matrix in said dual space.

According to a third aspect, a computer program product is provided, including a program code for carrying out, when implemented on a processor, the method according to the second aspect and its implementation forms.

The computer program product according to the third aspect comprises the features of the corresponding implementation forms of the method of the second aspect.

The method according to the second aspect and the computer program product according to the third aspect and their implementation forms provide the same advantages and effects as described above for the device of the second aspect and its respective implementation forms.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which:

FIG. 1 schematically depicts a decoder device according to this disclosure;

FIG. 2 schematically depicts a decoder device according to this disclosure;

FIG. 3 depicts a first matrix and a submatrix on which GE is performed according to this disclosure;

FIG. 4 schematically depicts a decoder device according to this disclosure;

FIG. 5 depicts the first matrix and another submatrix on which GE is performed according to this disclosure;

FIG. 6 shows an exemplary flowchart for performing decoding according to this disclosure;

FIG. 7 shows an exemplary flowchart for performing decoding according to this disclosure;

FIG. 8 schematically depicts a decoder device according to this disclosure;

FIG. 9a)-b) schematically depict a matrix in a dual space of the code and submatrices on which GE is performed according to this disclosure.

FIG. 10 shows a method according to this disclosure for performing decoding.

### DETAILED DESCRIPTION OF EMBODIMENTS

The present disclosure and its solutions are based on the following considerations of the inventors regarding MRB-based decoders.

In conventional solutions, the MRB is constructed as follows:
A) Ordering the reliabilities associated with the hard decisions of the received values in decreasing order, which defines a first permutation λ₁.
B) Applying λ₁ to the received sequence and to the columns of the generator matrix associated with the code considered. Let y₁ and G₁ denote the resulting received sequence and generator matrix, respectively, and let l₁={0, N−1} be the corresponding indexing. We have |y_{1,i}|≤|y_{1,j}| for i,j∈l₁ and i<j, where y_{1,i} denotes the i-th element of the sequence y₁.
C) Performing GE on G₁ from left to right. The dependent columns found during the GE are then permuted after the last independent column found to obtain a matrix G₂ in systematic form, which defines a second permutation λ₂.
D) Applying λ₂ to the permuted received sequence y₁, which defines a second permuted received sequence y₂.

For a (N, K) linear block code of length N and dimension K, the MRB consists of the K positions corresponding to the (leftmost) set of independent columns found in step (C). If c₂ represents a codeword in the code defined by G₂, then

$${λ}_{1}^{- 1} ( {λ}_{2}^{- 1} ( {c}_{2} ) )$$

represents the corresponding codeword in the original code, where

$${λ}_{j}^{- 1}$$

represents the inverse permeation to λⱼ.

While the above procedure can be applied to any generator matrix of the code considered, a reduced echelon form (REF) representation G_{REF} of the code can be assumed, so that the K columns of identity belong to G_{REF} (where columns of identity are the K independent columns with Hamming weight 1). These K columns can be associated to the information positions of the code. The remaining N−K columns define the parity check part of the code, this submatrix is named as P.

Let B_{K} be the location set of the K identity columns of G_{REF} and let P_{N-K} be the location set of the N−K remaining parity positions of G_{REF}. Note that G_{REF} does not have to be the generator matrix G used for encoding but both G and G_{REF} define the same codebook.

For 0≤a<b<N, define I₁([a, b]) as a set of consecutives indices {a, a+1, . . . , b}⊂I₁, I₁ being a set of indices after the ordering defined in Step (B) above.

Define the set of indices given in Equations (1) to (4):

$${B}_{K , MR} as the intersection of {B}_{K} and {I}_{1} ( [ 0 , K - 1 ] ) . \qquad ( 1 )$$

$${B}_{K , LR} as the intersection of {B}_{K} and {I}_{1} ( [ K , N - 1 ] ) . \qquad ( 2 )$$

$${B}_{N - K , MR} as the intersection of {P}_{N - K} and {I}_{1} ( [ 0 , K , N - 1 ] ) . \qquad ( 3 )$$

$${B}_{N - K , LR} as the intersection of {P}_{N - K} and {I}_{1} ( [ K , N - 1 ] ) . \qquad ( 4 )$$

If the second permutation λ₂ is the identity function, then I₁([0, K−1]) and I₁([K, N−1]) correspond to the MRB and its dual, the least reliable basis (LRB) basis, respectively. This separation suggests that in λ₁(G_{REF}), the GE does not have to be applied to B_{K,MR}.

The present disclosure concerns with performing a restricted GE when a generator matrix of the code is obtained in a MRB-like basis.

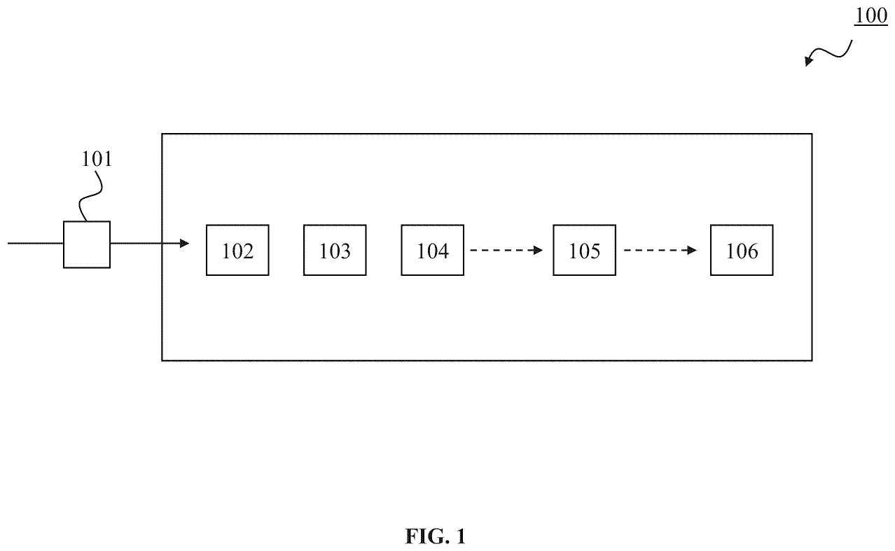

FIG. 1 shows an exemplary embodiment of a decoding device 100 for performing MRB-like decoding of a code having length N and dimension K, according to this disclosure.

The decoding device 100 according to this disclosure may comprise a processor or processing circuitry (not shown) configured to perform, conduct or initiate the various operations of the decoding device 100 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The decoding device 100 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the decoding device 100 to be performed. The processing circuitry may comprise one or more processors and a non-transitory memory connected to the one or more processors. The non-transitory memory may carry executable program code which, when executed by the one or more processors, causes the decoding device 100 to perform, conduct or initiate the operations or methods described herein.

The decoding device 100 is configured to receive a sequence y 101 of one or more channel observations.

Then, the decoding device 100 is configured to order one or more reliability values 102 in a decreasing order, each reliability value 102 corresponding to the channel observations of the received sequence y 101.

The decoding device 100 is further configured to determine the MRB-like basis 103 of the code based on the ordered reliability values 102. The MRB-like basis 103 is defined by K independent positions that are obtained from the ordering of the reliability values 102.

Next, the decoding device 100 is configured to construct a generator matrix 105 of the code from an ordering determined by the MRB-like basis 103 using GE. The GE is performed on a submatrix of a first matrix 104, and the first matrix 104 is derived from a reduced echelon form generator matrix of the code.

The submatrix on which the GE is performed defines at most K information positions of the code.

Further, the decoding device 100 is configured to perform decoding 106 based on the constructed generator matrix 105.

Determining the MRB-like basis 103 of the code based on the ordered reliability values 102 comprises the following.

The decoding device 100 is configured to define a first permutation function λ₁ as the ordered reliability values 102.

Next, the decoding device 100 is configured to construct first matrix 104, denoted as G₁, based on the ordered reliability values 102 and based on a generator matrix of the code. The generator matrix of the code is the reduced echelon form generator matrix of the code G_{REF}.

The construction, by the decoding device 100, of the first matrix G₁ 104 based on the ordered reliability values 102 and based on the generator matrix of the code comprises obtaining the first matrix G₁ 104 by applying the first permutation function λ₁ to the matrix G_{REF} as λ₁(G_{REF}), where the matrix G_{REF} is the reduced echelon form generator matrix of the code, and where K columns of G_{REF} are related to information positions of the code and one or more N−K columns of G_{REF} are related to parity positions of the code.

The construction, by the decoding device 100, of the first matrix G₁ 104 based on the ordered reliability values 102 and based on the generator matrix of the code further comprises performing one or more column permutations to bring |B_{K,MR}| columns of the first matrix G₁ 104 to first |B_{K,MR}| positions, and performing one or more row permutations to form an identity matrix in the first |B_{K,MR}| positions, where |B_{K,MR}| is a cardinality of the set of indices B_{K,MR}.

The set of indices B_{K,MR}, defined in Equation (1), comprises a set of indices of the information positions in G_{REF} that belongs to a set of the K most reliable positions.

Further, the construction, by the decoding device 100, of the first matrix G₁ 104 based on the ordered reliability values 102 and based on the generator matrix of the code comprises performing one or more column permutations to bring |B_{K,LR}| columns of the first matrix G₁ 104 to bring first |B_{K,LR}| positions in last N−K positions, and performing one or more row permutations to form an identity matrix in the first |B_{K,LR}| positions, where |B_{K,LR}| is a cardinality of the set of indices B_{K,LR}.

The set of indices B_{K,LR}, defined in Equation (2), is a set of indices of the information positions in G_{REF} that belongs to a set of the N−K least reliable positions.

After the above-disclosed column and/or row permutations, the first matrix G₁ 104 is obtained, which has a form given in Equation (5):

$${G}_{1} = [ \begin{matrix}{I}_{\vert {B}_{K , MR} \vert} & {P}_{a} & 0 & {P}_{c} \\ 0 & {P}_{b} & {I}_{\vert {B}_{K , LR} \vert} & {P}_{d}\end{matrix} ] , \qquad ( 5 )$$

where Pₐ is a |B_{K,MR}|×(K−|B_{K,LR}|) matrix, P_{b} is a |B_{K,LR}|×(K−|B_{K,LR}|) matrix, P_{c} is a |B_{K,MR}|×(N−K−|B_{K,LR}|) matrix. and P_{d} is a |B_{K,LR}|×(N−K−|B_{K,LR}|) matrix.

The submatrix

$$[ \begin{matrix}{P}_{a} \\ {P}_{b}\end{matrix} ]$$

in the first matrix G₁ 104 corresponds to the columns of P (i.e., the parity check part of G_{REF}), whose locations belong to I₁([0, K−1]) after applying the permutation λ₁. Similarly, the submatrix

$$[ \begin{matrix}{P}_{c} \\ {P}_{d}\end{matrix} ]$$

corresponds to the columns of P (i.e., the parity check part of G_{REF}), whose locations belong to I₁([K, N−1]) after the applying the permutation λ₁.

In this exemplary embodiment, constructing the generator matrix 105 from the ordering determined by the MRB-like basis 103 using GE performed on the submatrix of the first matrix 104 comprises obtaining, by the decoding device 100, a second matrix

$${G}_{1}^{2}$$

by performing GE on a submatrix of the first matrix G₁ 104.

Further, constructing the generator matrix 105 from the ordering determined by the MRB-like basis 103 using GE performed on the submatrix of the first matrix 104 comprises defining, by the decoding device 100, a second permutation function λ₂ by performing one or more column permutations on the second matrix

$${G}_{1}^{2}$$

to bring |B_{K,LR}| columns of

$${G}_{1}^{2}$$

to first |B_{K,LR}| positions, and performing one or more row permutations on

$${G}_{1}^{2}$$

to form an identity matrix in the first |B_{K,LR}| positions.

Further, constructing the generator matrix 105 from the ordering determined by the MRB-like basis 103 using GE performed on the submatrix of the first matrix 104 comprises constructing, by the decoding device 100, the generator matrix 105 as the permuted second matrix

$${G}_{1}^{2} .$$

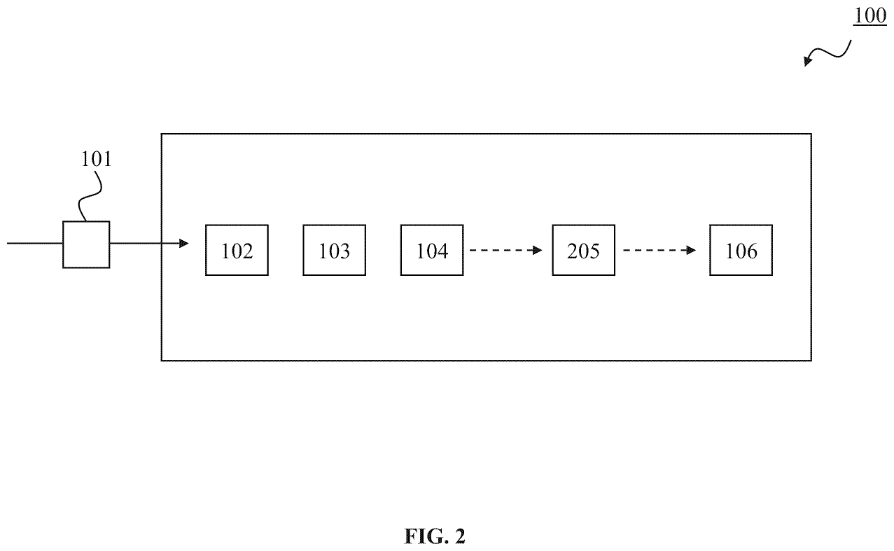

FIG. 2 shows an exemplary embodiment of the decoding device 100 according to this disclosure, which builds on the decoding device 100 shown in FIG. 1. Same elements are labelled with the same reference signs.

The afore-detailed description may be applied to the decoding device 100 of FIG. 1, except for the hereinafter-mentioned noticeable differences.

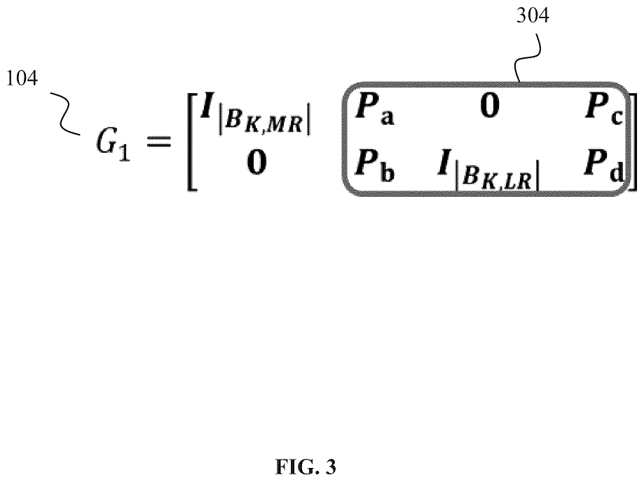

In the embodiment of FIG. 2, the first submatrix comprises a K×(|B_{K,LR}|+N−K) submatrix 304 of the first matrix G₁ 104, and the constructed generator matrix 105 is a matrix G₂ 205. The submatrix 304 and the first matrix G₁ 104 are shown in FIG. 3.

That is, the decoding device 100 performs GE on said submatrix 304 and further defines the second permutation function λ₂, by performing one or more column permutations and the one or more row permutations, as explained above in the embodiment of FIG. 1. The details are not repeated again here. As a result, the generator matrix 105 is constructed, and is denoted as G₂ 205

In this embodiment, once GE has been completed on the submatrix 304 and after applying the second permutation function λ₂, the resulting matrix G₂ 205 can be expressed as Equation (6):

$${G}_{2} = [ \begin{matrix}{I}_{\vert {B}_{K , MR} \vert} & 0 & {P}_{11} & {P}_{12} \\ 0 & {I}_{\vert {B}_{K , LR} \vert} & {P}_{21} & {P}_{22}\end{matrix} ] , \qquad ( 6 )$$

where the matrices Pᵢⱼ, i, j∈{1,2}, are matrices obtained by GE after the permutation λ₂. The identity matrix I_{|B}_{_{K,LR}}_{|} in G₂ is obtained after some of the column and/or permutations defined by λ₂, similar to I_{|B}_{_{K,MR}}_{|} as obtained in G₁.

The identity part of G₂ may not correspond to the MRB due to dependency occurrences; however, the discrepancy between the MRB-like basis and the MRB is small.

In this embodiment, upon calculation of the matrix G₂ 205, the decoding device 100 may perform decoding in a conventional fashion. That is, decoding can be performed directly using the matrix G₂ 205, i.e., with no need to further adaption.

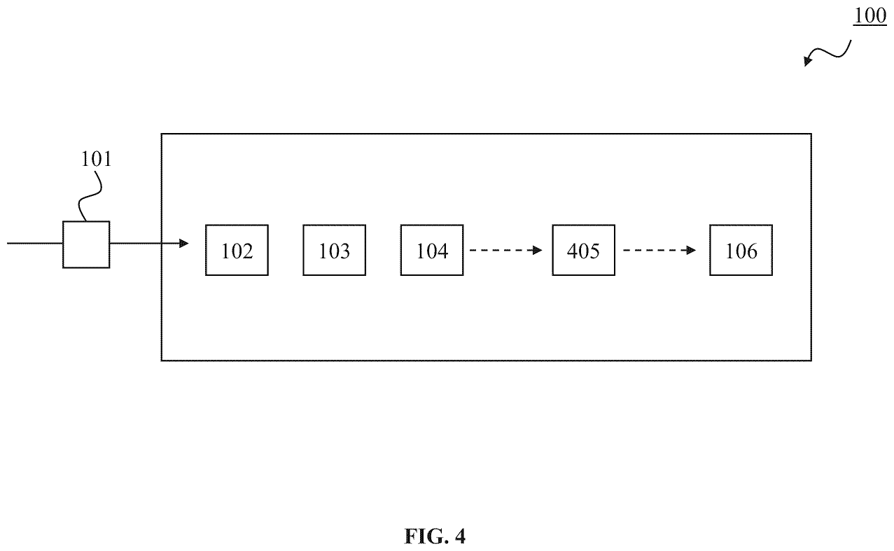

FIG. 4 shows an exemplary embodiment of the decoding device 100 according to this disclosure, which builds on the decoding device 100 shown in FIG. 1. Same elements are labelled with the same reference signs.

The afore-detailed description may be applied to the decoding device 100 of FIG. 1, except for the hereinafter-mentioned noticeable differences.

In the embodiment of FIG. 4, the first submatrix a |B_{K,LR}|×(|B_{K,LR}|+N−K) submatrix 504 of the first matrix G₁ 104, and the constructed generator matrix 105

$${G}_{2}^{′}$$

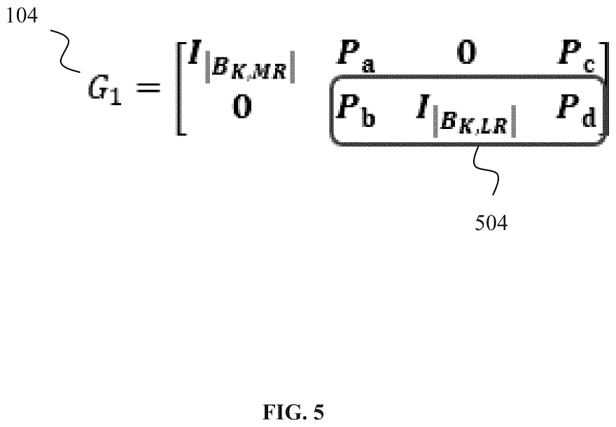

505. The submatrix 504 and the first matrix G₁ 104 are shown in FIG. 5.

Thereby, in this exemplary embodiment, GE is applied to only the |B_{K,LR}| rows with all-0 vector in the most reliable positions (MRPs) of B_{K,MR} as explained next. That is, the restricted GE is applied only to the non-zero part of the second row of the matrix G₁ 104, which is indicated in FIG. 5.

Then, after having identified by the decoding device 100 the remaining most reliable independent positions, the second permutation λ₂ is defined and applied. For the details regarding the second permutation λ₂, reference is made to the embodiment of FIG. 1.

The resulting matrix

$${G}_{2}^{′}$$

(405) can be expressed mi Equation (7):

$${G}_{2}^{′} = [ \begin{matrix}{I}_{\vert {B}_{K , MR} \vert} & {P}_{11}^{′} & 0 & {P}_{12}^{′} \\ 0 & {I}_{\vert {B}_{K , LR} \vert} & {P}_{21}^{′} & {P}_{22}^{′}\end{matrix} ] , \qquad ( 7 )$$

where the matrices P′ᵢⱼ, i, j∈{1,2} are matrices obtained by GE after the permutation λ₂. The identity matrix I_{|B}_{_{K,LR}}_{|} in

$${G}_{2}^{′}$$

is obtained by column and/or row permutations once GE has been completed, as explained in the embodiments of FIG. 1 and FIG. 2. The details are not repeated again here.

In this exemplary embodiment, decoding may be modified based on the constructed matrix

$${G}_{2}^{′}$$

405. That is, performing decoding 106 based on the constructed generator matrix 405 comprises constructing one or more error vectors, determining one or more codewords based on the constructed generator matrix 405 and based on the one or more error vectors; and further estimating a message based on the determined one or more codewords and based on a decision rule.

Hereinafter in this disclosure the terms error vector and error pattern may be used interchangeably.

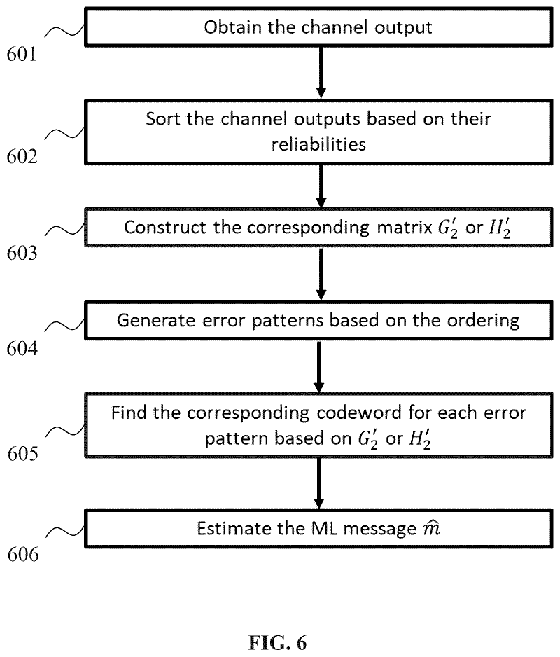

FIG. 6 schematically shows a flowchart for the decoding device 100 shown in FIG. 4 according to this disclosure.

In a step 601, the decoding device 100 may obtain the one or more channel observations.

Then, in a step 602, the decoding device 100 may sort (or order) the one or more channel observations based on their reliabilities.

In a step 606, the decoding device 100 may construct the generator matrix

$${G}_{2}^{′}$$

405 as explained above.

In a step 604, the decoding device 100 may further generate one or more error patterns based on the ordering.

Further, in a step 605, the decoding device 100 may determined a corresponding code word for each error pattern based on the generator matrix

$${G}_{2}^{′}$$

405.

Next, in a step 606, a message can be estimated by the decoding device based on the one or more error patterns.

In an embodiment, ordered statistic decoding (OSD) decoding can be modified to use the constructed generator matrix

$${G}_{2}^{′}$$

405. OSD is a family of MRIP-based universal decoders. In this approach, after making hard decision on the MRIPs, errors patterns are added to the resulting hard decision vector in a deterministic order within families of increasing Hamming weight to form an information vector. The corresponding codewords are constructed by encoding each of these information vectors. This encoding is performed based on a generator (or parity check) matrix of the code in systematic form which corresponds to the information vector.

Adaption of OSD decoding by using the constructed generator matrix

$${G}_{2}^{′}$$

405 is explained in the following.

The decoding device 100 constructs the one or more error vectors, comprising determining an ordered received sequence of channel observations

$${y}^{′} = ( {y}_{0}^{′} , {y}_{1}^{′} , … , {y}_{N - 1}^{′} )$$

corresponding to the generator matrix of the code

$${G}_{2}^{′}$$

### 405. Here,

$${y}_{i}^{′}$$

with i=0, 1, . . . , N−1 denotes an i-th element of the ordered sequence y′.

Next, the decoding device 100 determines a hard decision decoding

$${z}^{′} = ( {z}_{0}^{′} , {z}_{1}^{′} , … , {z}_{N - 1}^{′} )$$

corresponding to the ordered received sequence y′, where

$${z}_{i}^{′}$$

with i=0, 1, . . . , N−1 denotes an i-th element of the hard decision decoding z′.

Further, the decoding device 100 creates a list of candidates [symbol] of a transmitted message comprising one or more elements j. Each element j is obtained by adding a respective error vector

$${e}_{j}^{′} = ( {e}_{j , 0}^{′} , {e}_{j , 1}^{′} , … , {e}_{j , K - 1}^{′} )$$

to a vector

$${z}_{K}^{′} = ( {z}_{0}^{′} , {z}_{1}^{′} , … , {z}_{K - 1}^{′} ) ,$$

wherein

$${e}_{j , i}^{′}$$

with i=0, 1, . . . , K−1 denotes an i-th element of a respective j-th error vector

$${e}_{j}^{′} .$$

The vector

$${z}_{K}^{′} = ( {z}_{0}^{′} , {z}_{1}^{′} , ... , {z}_{K - 1}^{′} )$$

may be also included in the list [symbol] when an added error vector is equal to zero

Each error vector may be constructed in a-priori likelihood manner, for example based on a corresponding decreasing or increasing a-prior likelihood, or each error vector may be constructed in a deterministic order within one or more families of increasing Hamming weight, or any combination thereof. For example, the decoding device may consider all possible error vectors with Hamming weight less than some predetermined number w, or other generations of error patterns can be used.

Determining, by the decoding device 100, the one or more codewords based on the constructed generator matrix 405 and based on the one or more error patterns comprises determining an order-zero codeword

$${c}_{0}^{′}$$

for the vector

$${z}_{K}^{′} = ( {z}_{0}^{′} , {z}_{1}^{′} , ... , {z}_{K - 1}^{′} )$$

based on the constructed generator matrix

$${G}_{2}^{′}$$

405.

Further, determining, by the decoding device 100, the one or more codewords based on the constructed generator matrix 405 and based on the one or more error patterns comprises determining a codeword

$${c}_{j}^{′}$$

for each of a respective j-th error vector

$${e}_{j}^{′}$$

in the list [symbol] , based on the calculated order-zero codeword

$${c}_{0}^{′}$$

and based on the constructed generator matrix

$${G}_{2}^{′}$$

405.

Determining the order-zero codeword

$${c}_{0}^{′}$$

for the vector

$${z}_{K}^{′} = ( {z}_{0}^{′} , {z}_{1}^{′} , ... , {z}_{K - 1}^{′} )$$

based on the constructed generator matrix

$${G}_{2}^{′}$$

405 comprises: decomposing

$${z}_{K}^{′}$$

based on

$${G}_{2}^{′}$$

405 as

$${z}_{K}^{′} = ( \begin{matrix}{z}_{K , MR}^{′} & {z}_{K , LR}^{′}\end{matrix} ) .$$

with

$${z}_{K , MR}^{′} = ( {z}_{0}^{′} , {z}_{1}^{′} , ... , {z}_{\vert {B}_{K , MR} \vert - 1}^{′} ) and {z}_{K , LR}^{′} = ( {z}_{\vert {B}_{K , MR} \vert}^{′} , {z}_{\vert {B}_{K , MR} \vert + 1}^{′} , ... , {z}_{K - 1}^{′} ) .$$

Next, the decoding device 100 may calculate the order-zero codeword

$${c}_{0}^{′}$$

using a two-stage operation.

First, the decoding device 100 may calculate a quantity

$${c}_{MR}^{′}$$

and a quantity

$${c}_{LR}^{′}$$

give in Equations (8) and (9) respectively:

$${c}_{MR}^{′} = {z}_{K , MR}^{′} [ {I}_{\vert {B}_{K , MR} \vert} {P}_{11} 0 {P}_{12} ] = ( {z}_{K , MR}^{′} {c}_{11}^{′} 0 {c}_{12}^{′} , \qquad ( 8 )$$

$${c}_{LR}^{′} = ( {z}_{K , LR}^{′} + {c}_{11}^{′} ) [ 0 {I}_{\vert {B}_{K , LR} \vert} {P}_{21} {P}_{22} ] = ( 0 {z}_{K , LR}^{′} + {c}_{11}^{′} {c}_{21}^{′} {c}_{22}^{′} ) . \qquad ( 9 )$$

That is,

$${c}_{MR}^{′}$$

is determined based on a product of

$${z}_{K , MR}^{′}$$

and |B_{K,MR}| rows of

$${G}_{2}^{′}$$

405, see Equation (7) above, and

$${c}_{LR}^{′}$$

is determined based on a product of

$${z}_{K , LR}^{′}$$

and the remaining |B_{K,LR}| rows of

$${G}_{2}^{′}$$

405.

Next, the decoding device 100 determines the order-zero codeword

$${c}_{0}^{′}$$

defined as in Equation (10):

$${c}_{0}^{′} = {c}_{MR}^{′} + {c}_{LR}^{′} = ( {z}_{K , MR}^{′} {z}_{K , MR}^{′} {c}_{21}^{′} {c}_{12}^{′} + {c}_{22}^{′} ) . \qquad ( 10 )$$

Determining the codeword

$${c}_{j}^{′}$$

for each of the respective j-th error vector

$${e}_{j}^{′}$$

in the list [symbol] , based on the calculated order-zero codeword

$${c}_{0}^{′}$$

and based on the calculated generator matrix

$${G}_{2}^{′}$$

405 comprises decomposing the j-th error vector

$${e}_{j}^{′}$$

in the list [symbol] based on

$${G}_{2}^{′}$$

405 as

$${e}_{j}^{′} = ( \begin{matrix}{e}_{j , K , MR}^{′} & {e}_{j , K , LR}^{′}\end{matrix} )$$

with

$${e}_{j , K , MR}^{′} = ( {e}_{j , 0}^{′} , {e}_{L , 1}^{′} , … , {e}_{j , \vert {B}_{K , MR} \vert - 1}^{′} )$$

$$and$$

$${e}_{j , K , LR}^{′} = ( {e}_{j , \vert {B}_{K , MR} \vert}^{′} , {e}_{j , \vert {B}_{K , MR} \vert + 1}^{′} , … , {e}_{j , K - 1}^{′} ) .$$

The decoding device 100 then calculates a quantity

$${e}_{j , MR}^{′}$$

and a quantity

$${e}_{j , LR}^{′}$$

### as in Equations (11) and (12):

$${e}_{j , MR}^{′} = {e}_{j , K , MR}^{′} [ {I}_{\vert {B}_{K , MR} \vert} {P}_{11} 0 {P}_{12} ] = ( {e}_{j , K , MR}^{′} {e}_{j , 11}^{′} 0 {e}_{j , 12}^{′} ) , \qquad ( 11 )$$

$$\begin{matrix}{e}_{j , LR}^{′} = ( {e}_{j , K , LR}^{′} + {e}_{j , 11}^{′} ) [ 0 {I}_{\vert {B}_{K , LR} \vert} {P}_{21} {P}_{22} ] \\ = ( 0 {e}_{j , K , LR}^{′} + {e}_{j , 11}^{′} {e}_{j , 21}^{′} {e}_{j , 22}^{′} ) .\end{matrix} \qquad ( 12 )$$

That is,

$${e}_{j , MR}^{′}$$

is determined based on a product of

$${e}_{j , K , MR}^{′}$$

and |B_{K,MR}| rows of

$${G}_{2}^{′}$$

405, and

$${e}_{j , LR}^{′}$$

is determined based on a product of

$${e}_{j , K , LR}^{′}$$

and the remaining |B_{K,LR}| rows of

$${G}_{2}^{′}$$

405, see Equation (7) above.

Then, the decoding device 100 determines the respective codeword

$${c}_{j}^{′}$$

for the j-th error vector

$${e}_{j}^{′}$$

in the list [symbol] as defined as in Equation (13):

$${c}_{j}^{′} = {c}_{0}^{′} + {e}_{j , MR}^{′} + {e}_{j , LR}^{′} . \qquad ( 13 )$$

Consequently, the codewords corresponding to the candidate list [symbol] may be obtained with the two-stage operation, as explained above.

Further, estimating, by the decoding device 100, the message based on the determined one or more codewords comprises choosing a j-th candidate message in the list [symbol] having a maximum likelihood decision.

The maximum likelihood decision is defined as in Equation (14):

$$j = arg max P ( {c}_{j}^{′} \vert y ) , \qquad ( 14 )$$

where

$$P ( {c}_{j}^{′} \vert y )$$

denotes a probability of transmitting the codeword

$${c}_{j}^{′}$$

given the received sequence y 101 of one or more channel observations.

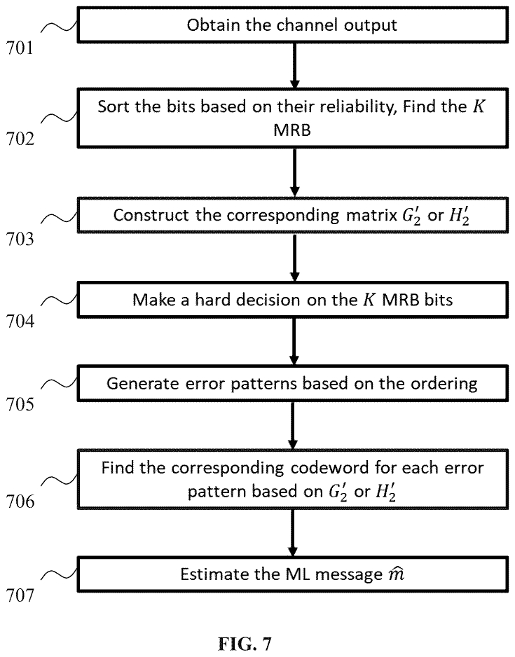

FIG. 7 schematically shows a flowchart for OSD decoding performed by the decoding device 100 shown in FIG. 4 according to this disclosure.

In a step 701, the decoding device 100 may obtain the one or more channel observations.

In a step 702, the decoding device 100 may sort (or order) the bits in the received one or more channel observations based on their reliabilities. Further, the decoding device may obtain K positions in the MRB-like basis.

In a step 703, the decoding device 100 may construct the generator matrix

$${G}_{2}^{′}$$

405.

In a next step 704, the decoding device 100 may perform a hard decision on the K MRB-like bits.

Further, in a step 705, the decoding device 100 may generate one or more error patterns based on the ordering.

Next, in a step 706, the decoding device 100 may determine a corresponding code word for each error pattern based on the generator matrix

$${G}_{2}^{′}$$

405.

In a step 707, the decoding device 100 may estimate a message based on the one or more error patterns.

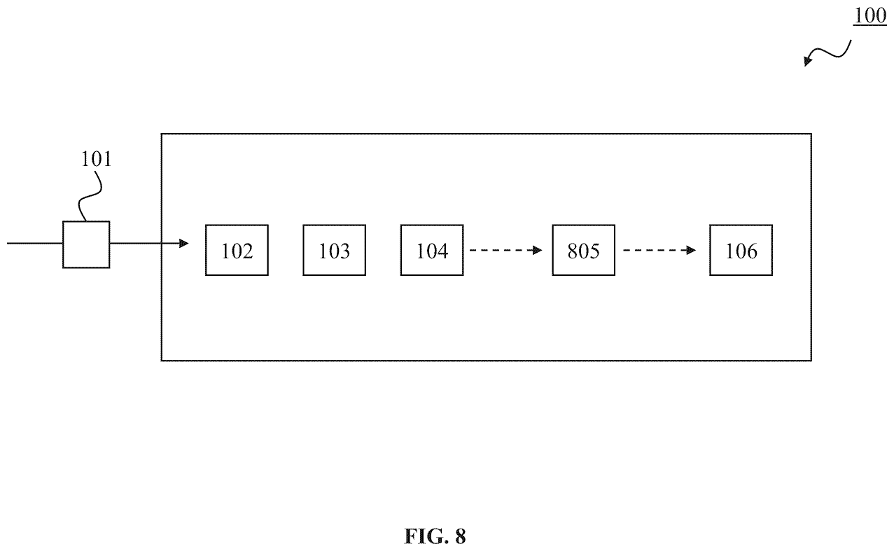

FIG. 8 shows an exemplary embodiment of the decoding device 100 according to this disclosure, which builds on the decoding device 100 shown in FIG. 1, FIG. 3 and FIG. 4. Same elements are labelled with the same reference signs.

The afore-detailed description may be applied to the decoding device 100 of FIG. 1, FIG. 2 and FIG. 3 except for the hereinafter-mentioned noticeable differences. In the exemplary embodiment of FIG. 8, the constructed generator matrix 105 comprises a parity matrix 805 in a dual space of the code.

Thereby, the features performed by the decoding device 100 disclosed above can be applied in the dual space (or H-space.)

In the dual space, a parity check matrix of the code defined by the first matrix G₁ 104 has the same form given by Equation (15):

$${H}_{1} = [ \begin{matrix}{Q}_{d} & {I}_{\vert {P}_{N - K , MR} \vert} & {Q}_{b} & 0 \\ {Q}_{c} & 0 & {Q}_{a} & {I}_{\vert {P}_{N - K , LR} \vert}\end{matrix} ] . \qquad ( 15 )$$

where the matrices Q_{b}, Q_{b}, Q_{c} and Q_{d}, are defined from the matrices Pₐ, P_{b}, P_{c}, and P_{d} in G₁ 104, see Equation (5), based on

$${G}_{1} {H}_{1}^{T} = 0.$$

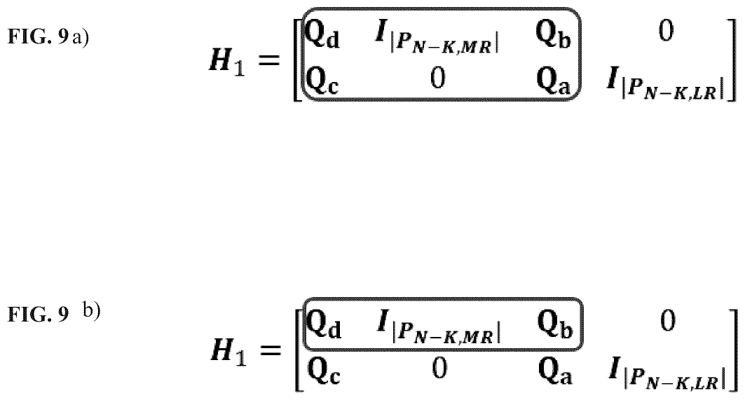

Similar operations as disclosed above can be done on the parity check matrix H₁, such that to build parity matrix H₂. GE is applied on a submatrix of H₁ that is depicted in FIG. 9a).

Once GE has been completed, the resulting matrix H₂ can be expressed as in Equation (16):

$${H}_{2} = [ \begin{matrix}{Q}_{22} & {Q}_{21} & {I}_{\vert {P}_{N - K , MR} \vert} & 0 \\ {Q}_{12} & {Q}_{11} & 0 & {I}_{\vert {P}_{N - K , LR} \vert}\end{matrix} ] , \qquad ( 16 )$$

where the matrices Qᵢⱼ, i, j∈{1,2} are matrices obtained by GE after applying a respective permutation λ₂. The identity matrix I|_{P}_{_{N-K,MR}}_{|} in H₂ is obtained after performing one or more column permutations and/or one or more row permutations as for I_{|P}_{_{N-K,LR}}_{|} in H₁.

It is to be noted that the GE performed on the submatrix of H₁ is done from right to left, in contrast to the case for the generator matrix G₁ 104.

Then, the decoding device 100 may perform decoding using the constructed matrix H₂ in the dual space of the code.

Alternatively, a generator matrix

$${H}_{2}^{′}$$

may be constructed by performing GE in another submatrix of H₁, which is depicted in FIG. 9b).

Once GE has been completed, and after applying a second permutation, the resulting matrix

$${H}_{2}^{′}$$

can be expressed as in Equation (17):

$${H}_{2}^{′} = [ \begin{matrix}{Q}_{22}^{′} & {Q}_{12}^{′} & {I}_{\vert {P}_{N - K , MR} \vert} & 0 \\ {Q}_{21}^{′} & 0 & {Q}_{11}^{′} & {I}_{\vert {P}_{N - K , LR} \vert}\end{matrix} ] , \qquad ( 17 )$$

where the matrices

$${Q}_{ij}^{′} ,$$

i,j∈{1,2} are matrices obtained by GE after the respective second permutation λ₂. Note that this permutation λ₂ is applied to the corresponding columns in H₁.

The GE operation on the submatrix of H₁ is also done from right to left, in contrast to the case for the generator matrix G₁ 104.

The decoding device 100 may then perform decoding based on the constructed generator matrix 805; that is, decoding should be appropriately modified so that the generator matrix 805 in the dual space

$${H}_{2}^{′}$$

is used.

The exemplary flowcharts of FIG. 6 and FIG. 7 also apply for the modified decoding using the generator matrix

$${H}_{2}^{′}$$

(alternatively to using the generator matrix

$${G}_{2}^{′} ) .$$

In another embodiment, the two-step complete information set decoding based on

$${G}_{2}^{′} or {H}_{2}^{′}$$

can be generalized into more stages to further reduce the complexity of GE. For example, for a given number α, the constructed generator matrix 105 corresponding to three stages has the form given in Equation (18):

$${G}_{3}^{′} = [ \begin{matrix}{I}_{\vert {B}_{K , MR} \vert} & {P}_{11} & {P}_{12} & 0 & {P}_{13} \\ 0 & {I}_{\vert {B}_{K , LR} \vert - α} & {P}_{21} & {P}_{22} & {P}_{23} \\ 0 & 0 & {I}_{α} & {P}_{31} & {P}_{33}\end{matrix} ] , \qquad ( 18 )$$

with a GE of complexity (N−|B_{K,MR}|)(|B_{K,LR}|−α)|B_{K,MR}|+(N−K+α) α³.

As an example, for a (256,128) binary linear code and assuming that |B_{K,LR}|=|P_{N-K,MR}|=64, the following is obtained:
The complexity of full GE is: 256×128×128=4, 194, 304.
The complexity of two stage reduced GE is: 192×64×64=786, 432.
The complexity of three stage reduced GE with α=34 is: 192×30×64+162×34×34=555, 912.
The complexity of three stage reduced GE with

$$α = \frac{\vert {B}_{K , LR} \vert}{2} = 32$$

is: 192×32×64+160×32×32=559, 992.

For the exemplary embodiments of the decoding device 100 according to this disclosure shown in FIG. 4 and FIG. 8, it can be noted that the cardinalities of B_{K,LR} and P_{N-K,MR} satisfy the relation given in Equation (19):

$$\vert {B}_{K , LR} \vert = \vert {P}_{N - K , MR} \vert \leq min \{ K , N - K \} . \qquad ( 19 )$$

To obtain the matrix

$${G}_{2}^{′}$$

405, GE is applied to the (|B_{K,LR}|)×(|B_{K,LR}|+N−K) submatrix 504, with |B_{K,LR}|≤N−K. Hence its complexity becomes O((N−K)³). Accordingly, the complexity of GE performed in a submatrix according to this disclosure becomes O(min {K, N−K}³). Similarly, the matrix the generator matrix

$${H}_{2}^{′}$$

805 may be obtained with complexity O (K³).

Hence, the complexity of GE in the two-stage operation disclosed above becomes O(min {K, N−K}³).

Further, in the embodiments of the decoding device 100 according to this disclosure, the number of rows processed by GE can be bound to a quantity Bₘₐₓ in order to further control the size of the restricted GE in the case of large N−K, for which the restricted GE may still be quite complex.

Therefore for |B_{K,LR}|>Bₘₐₓ, the first matrix G₁ 104 takes the form given in Equation (20):

$${G}_{1}^{B} = [ \begin{matrix}{I}_{K - {B}_{max}} & {P}_{11}^{B} & 0 & {P}_{12}^{B} \\ 0 & {P}_{21}^{B} & {I}_{{B}_{max}} & {P}_{22}^{B}\end{matrix} ] \qquad ( 20 )$$

$$where :$$

$${P}_{11}^{B} is ( K - {B}_{max} ) \times {B}_{max} ,$$

$${P}_{12}^{B} is ( K - {B}_{max} ) \times ( N - K - {B}_{max} ) ,$$

$${P}_{21}^{B} is {B}_{max} \times {B}_{max} , and$$

$${P}_{22}^{B} is {B}_{max} \times ( N - K - {B}_{max} ) .$$

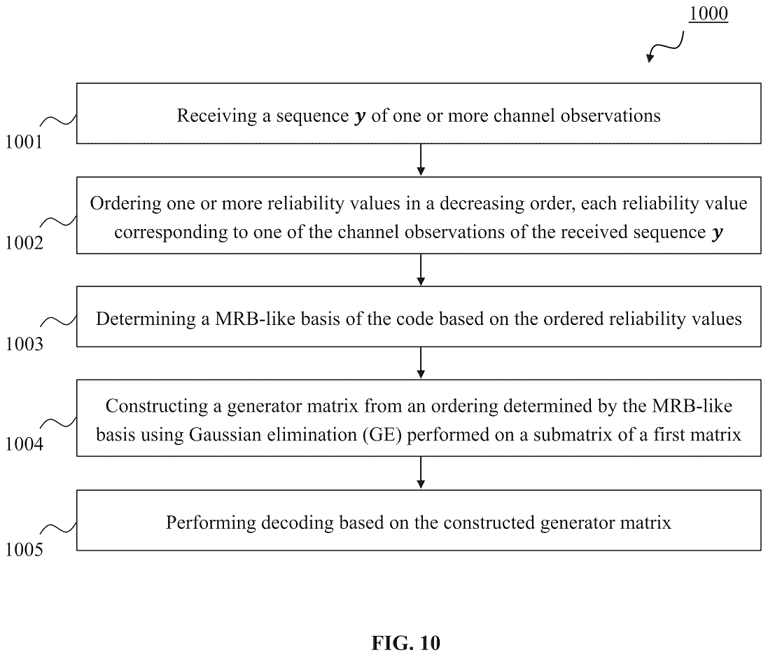

FIG. 10 shows an exemplary embodiment of a method 1000 for performing most reliable basis-like, MRB-like, decoding of a code having length N and dimension K. The method 1000 may be performed by the exemplary embodiments of the decoding device 100 according to this disclosure.

The method 1000 comprises a step 1001 of receiving a sequence y 101 of one or more channel observations 102.

Then, the method 1000 comprises a step 1002 of ordering one or more reliability values 102 in a decreasing order, each reliability value 102 corresponding to one of the channel observations of the received sequence y 101.

Further, in step 1003, the method 1000 comprises determining a MRB-like basis 103 of the code based on the ordered reliability values 102, where the MRB-like basis 103 is defined by K independent positions that are obtained from the ordering.

The method 1000 comprises a step 1004 of constructing 1 a generator matrix 105 from an ordering determined by the MRB-like basis 103 using GE performed on a submatrix of a first matrix 104, the first matrix 104 being derived from a reduced echelon form generator matrix of the code.

The method 1000 further comprises a step 1005 of performing decoding based on the constructed generator matrix 105.

The method 1000 may further comprise actions according to the exemplary embodiments of the decoding device 100 shown in FIG. 1, FIG. 2, FIG. 4 and FIG. 8. Hence, the method 1000 achieves the same advantages as the disaggregated compute system 100 disclosed above.

This disclosure further provides a computer program product comprising a program code for carrying out, when implemented on a processor, the method 1000. The computer program may be included in a computer readable medium of the computer program product. The computer readable medium may comprise essentially any memory, such as a ROM (Read-Only Memory), a PROM (Programmable Read-Only Memory), a 15 EPROM (Erasable PROM), a Flash memory, an EEPROM (Electrically Erasable PROM), or a hard disk drive.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A decoding device (100) for performing most reliable basis-like, MRB-like, decoding of a code having length N and dimension K, the decoding device (100) being configured to:
receive a sequence y (101) of one or more channel observations;
order one or more reliability values (102) in a decreasing order, each reliability value (102) corresponding to the channel observations of the received sequence y (101);
determine a MRB-like basis (103) of the code based on the ordered reliability values (102), wherein the MRB-like basis (103) is defined by K independent positions that are obtained from the ordering;
construct a generator matrix (105) from an ordering determined by the MRB-like basis (103) using Gaussian elimination, GE, performed on a submatrix of a first matrix (104), the first matrix (104) being derived from a reduced echelon form generator matrix of the code; and
perform decoding (106) based on the constructed generator matrix (105).

2. The decoding device (100) according to claim 1, wherein the submatrix defines at most K information positions of the code.

3. The decoding device (100) according to claim 1, wherein determining the MRB-like basis (103) of the code based on the ordered reliability values (102) comprises:
defining a first permutation function λ₁ as the ordered reliability values (102);
constructing the first matrix G₁ (104) based on the ordered reliability values (102) and based on a generator matrix of the code.

4. The decoding device (100) according to claim 3, wherein constructing the first matrix G₁ (104) based on the ordered reliability values (102) and based on the generator matrix of the code comprises:
obtaining the first matrix G₁ (104) by applying the first permutation function λ₁ to a matrix G_{REF} as λ₁(G_{REF}), wherein the matrix G_{REF} is the reduced echelon form generator matrix of the code, and wherein K columns of G_{REF} are related to information positions of the code and one or more N−K columns of G_{REF} are related to parity positions of the code; and
performing one or more permutations in the first matrix G₁ (104), comprising:
performing one or more column permutations to bring |B_{K,MR}| columns of the first matrix G₁ (104) to first |B_{K,MR}| positions, and performing one or more row permutations to form an identity matrix in the first |B_{K,MR}| positions, wherein |B_{K,MR}| is a cardinality of a set of indices B_{K,MR}, the set of indices B_{K,MR} comprising a set of indices of the information positions in G_{REF} that belongs to a set of the K most reliable positions; and
performing one or more column permutations to bring |B_{K,LR}| columns of the first matrix G₁ (104) to bring first |B_{K,LR}| positions in last N−K positions, and performing one or more row permutations to form an identity matrix in the first |B_{K,LR}| positions, wherein |B_{K,LR}| is a cardinality of a set of indices B_{K,LR}, the set of indices B_{K,LR} being a set of indices of the information positions in G_{REF} that belongs to a set of the N−K least reliable positions.

5. The decoding device (100) according to claim 1, wherein constructing the generator matrix (105) from the ordering determined by the MRB-like basis (103) using GE performed on the submatrix of the first matrix (104) comprises:
obtaining a second matrix
$${G}_{1}^{2}$$
by performing GE of the first matrix G₁ (104);
defining a second permutation function λ₂ by performing one or more column permutations on the second matrix
$${G}_{1}^{2}$$
to bring |B_{K,LR}| columns of
$${G}_{1}^{2}$$
to first |B_{K,LR}| positions, and performing one or more row permutations on
$${G}_{1}^{2}$$
to form an identity matrix in the first |B_{K,LR}| positions; and
constructing the generator matrix (105) as the permuted second matrix
$${G}_{1}^{2} .$$

6. The decoding device (100) according to claim 1, wherein the first submatrix comprises a K×(|B_{K,LR}|+N−K) submatrix (304) of the first matrix G₁ (104) and the constructed generator matrix (105) is a matrix G₂ (205); or
wherein the first submatrix comprises a |B_{K,LR}|×(|B_{K,LR}|+N−K) submatrix (504) of the first matrix G₁ (104) and the constructed generator matrix is a matrix
$${G}_{2}^{′}$$
(405).

7. The decoding device (100) according to claim 1, wherein performing decoding (106) based on the constructed generator matrix (105) comprises:
constructing one or more error vectors;
determining one or more codewords based on the constructed generator matrix (105) and based on the one or more error vectors; and
estimating a message based on the determined one or more codewords and based on a decision rule.

8. The decoding device (100) according to claim 7, wherein constructing the one or more error vectors comprises:
determining an ordered received sequence of channel observations
$${y}^{′} = ( {y}_{0}^{′} , {y}_{1}^{′} , ... , {y}_{N - 1}^{′} )$$
corresponding to the generator matrix of the code
$${G}_{2}^{′}$$
(405), wherein
$${y}_{i}^{′}$$
with i=0, 1, . . . , N−1 denotes an i-th element of the ordered sequence y′;
determining a hard decision decoding
$${z}^{′} = ( {z}_{0}^{′} , {z}_{1}^{′} , ... , {z}_{N - 1}^{′} )$$
corresponding to the ordered received sequence y′, wherein
$${z}_{i}^{′}$$
with i=0, 1, . . . , N−1 denotes an i-th element of the hard decision decoding z′;
creating a list of candidates [symbol] of a transmitted message comprising one or more elements j, wherein each element j is obtained by adding a respective error vector
$${e}_{j}^{′} = ( {e}_{j , 0}^{′} , {e}_{j , 1}^{′} , ... , {e}_{j , K - 1}^{′} )$$
to a vector
$${z}_{K}^{′} = ( {z}_{0}^{′} , {z}_{1}^{′} , ... , {z}_{K - 1}^{′} ) , wherein {e}_{j , i}^{′}$$
with i=0, 1, . . . , K−1 denotes an i-th element of a respective j-th error vector
$${e}_{j}^{′} .$$

9. The decoding device (100) according to claim 7, wherein each error vector is constructed based on a corresponding decreasing likelihood; or
wherein each error vector is constructed in a deterministic order within one or more families of increasing Hamming weight.

10. The decoding device (100) according to claim 7, wherein determining the one or more codewords based on the constructed generator matrix (405) and based on the one or more error patterns comprises:
determining an order-zero codeword
$${c}_{0}^{′}$$
for the vector
$${z}_{K}^{′} = ( {z}_{0}^{′} , {z}_{1}^{′} , ... , {z}_{K - 1}^{′} )$$
based on the constructed generator matrix
$${G}_{2}^{′}$$
(405); and
determining a codeword
$${c}_{j}^{′}$$
for each of a respective j-th error vector
$${e}_{j}^{′}$$
in the list [symbol] , based on the calculated order-zero codeword
$${c}_{0}^{′}$$
and based on the constructed generator matrix
$${G}_{2}^{′} .$$

11. The decoding device (100) according to claim 10, wherein determining the order-zero codeword
$${c}_{0}^{′}$$
for the vector
$${z}_{K}^{′} = ( {z}_{0}^{′} , {z}_{1}^{′} , ... , {z}_{K - 1}^{′} )$$
based on the constructed generator matrix
$${G}_{2}^{′}$$
(405) comprises:
decomposing
$${z}_{K}^{′}$$
based on
$${G}_{2}^{′}$$
(405) as
$${z}_{K}^{′} = ( {z}_{K , MR}^{′} {z}_{K , LR}^{′} ) ,$$
with
$${z}_{K , MR}^{′} = ( {z}_{0}^{′} , {z}_{1}^{′} , … , {z}_{\vert {B}_{K , MR} \vert - 1}^{′} ) and$$
$${z}_{K , LR}^{′} = ( {z}_{\vert {B}_{K , MR} \vert}^{′} , {z}_{\vert {B}_{K , MR} \vert + 1}^{′} , … , {z}_{K - 1}^{′} ) ;$$
and
calculating the order-zero codeword as
$${c}_{0}^{′} = {c}_{MR}^{′} + {c}_{LR}^{′} ;$$
wherein
$${c}_{M R}^{′}$$
is determined based on a product of
$${z}_{K , MR}^{′}$$
and |B_{K,MR}| rows of
$${G}_{2}^{′}$$
(405); and
wherein
$${c}_{LR}^{′}$$
is determined based on a product of
$${z}_{K , LR}^{′}$$
and the remaining |B_{K,LR}| rows of
$${G}_{2}^{′} .$$

12. The decoding device (100) according to claim 10, wherein determining the codeword
$${c}_{j}^{′} ,$$
for each of the respective j-th error vector
$${e}_{j}^{′}$$
in the list [symbol] based on the calculated order-zero codeword
$${c}_{0}^{′}$$
and based on the calculated generator matrix
$${G}_{2}^{′}$$
(405) comprises:
decomposing the j-th error vector
$${e}_{j}^{′}$$
in the list [symbol] based on
$${G}_{2}^{′}$$
(405) as
$${e}_{j}^{′} = ( \begin{matrix}{e}_{j , K , MR}^{′} & {e}_{j , K , LR}^{′}\end{matrix} )$$
with
$${e}_{j , K , MR}^{′} = ( {e}_{j , 0}^{′} , {e}_{j , 1}^{′} , ... , {e}_{j , \vert {B}_{K , MR} \vert - 1}^{′} ) and {e}_{j , K , LR}^{′} = ( {e}_{j , \vert {B}_{K , MR} \vert}^{′} , {e}_{j , \vert {B}_{K , MR} \vert + 1}^{′} , ... , {e}_{j , K - 1}^{′} ) ;$$
calculating the respective codeword
$${c}_{j}^{′}$$
for the j-th error vector
$${e}_{j}^{′}$$
as
$${c}_{j}^{′} = {c}_{0}^{′} + {e}_{j , MR}^{′} + {e}_{j , LR}^{′} ;$$
wherein
$${e}_{j , MR}^{′}$$
is determined based on a product of
$${e}_{j , K , MR}^{′}$$
and |B_{K,MR}| rows of
$${G}_{2}^{′}$$
(405); and
wherein
$${e}_{j , LR}^{′}$$
is determined based on a product of
$${e}_{j , K , LR}^{′}$$
and the remaining |B_{K,LR}| rows of
$${G}_{2}^{′}$$
(405).

13. The decoding device (100) according to claim 7, wherein estimating the message based on the determined one or more codewords comprises:
choosing a j-th candidate message in the list [symbol] having a maximum likelihood decision, the maximum likelihood decision being defined as
$$j = argmax P ( {c}_{j}^{′} \vert y ) ,$$
wherein
$$P ( {c}_{j}^{′} \vert y )$$
denotes a probability of transmitting the codeword
$${c}_{j}^{′}$$
given the received sequence y (101).

14. The decoding device (100) according to claim 1, wherein the constructed generator matrix (105) comprises a parity matrix (805) in a dual space of the code.

15. A method (1000) for performing most reliable basis-like, MRB-like, decoding of a code having length N and dimension K, the method (1000) comprising:
receiving (1001) a sequence y (101) of one or more channel observations;
ordering (1002) one or more reliability values (102) in a decreasing order, each reliability value (102) corresponding to one of the channel observations of the received sequence y (101);
determining (1003) a MRB-like basis (103) of the code based on the ordered reliability values (102), wherein the MRB-like basis (103) is defined by K independent positions that are obtained from the ordering;
constructing (1004) a generator matrix (105) from an ordering determined by the MRB-like basis (103) using Gaussian elimination, GE, performed on a submatrix of a first matrix (104), the first matrix (104) being derived from a reduced echelon form generator matrix of the code; and
performing (1005) decoding based on the constructed generator matrix.

16. The method (1000) according to claim 15, wherein the submatrix defines at most K information positions of the code.

17. The method (1000) according to claim 15, wherein determining the MRB-like basis (103) of the code based on the ordered reliability values (102) comprises:
defining a first permutation function λ₁ as the ordered reliability values (102);
constructing the first matrix G₁ (104) based on the ordered reliability values (102) and based on a generator matrix of the code.

18. The method (1000) according to claim 17, wherein constructing the first matrix G₁ (104) based on the ordered reliability values (102) and based on the generator matrix of the code comprises:
obtaining the first matrix G₁ (104) by applying the first permutation function λ₁ to a matrix G_{REF} as λ₁(G_{REF}), wherein the matrix G_{REF} is the reduced echelon form generator matrix of the code, and wherein K columns of G_{REF} are related to information positions of the code and one or more N−K columns of G_{REF} are related to parity positions of the code; and
performing one or more permutations in the first matrix G₁ (104), comprising:
performing one or more column permutations to bring |B_{K,MR}| columns of the first matrix G₁ (104) to first |B_{K,MR}| positions, and performing one or more row permutations to form an identity matrix in the first |B_{K,MR}| positions, wherein |B_{K,MR}| is a cardinality of a set of indices B_{K,MR}, the set of indices B_{K,MR} comprising a set of indices of the information positions in G_{REF} that belongs to a set of the K most reliable positions; and
performing one or more column permutations to bring |B_{K,LR}| columns of the first matrix G₁ (104) to bring first |B_{K,LR}| positions in last N−K positions, and performing one or more row permutations to form an identity matrix in the first |B_{K,LR}| positions, wherein |B_{K,LR}| is a cardinality of a set of indices B_{K,LR}, the set of indices B_{K,LR} being a set of indices of the information positions in G_{REF} that belongs to a set of the N−K least reliable positions.

19. The method (1000) according to claim 15, wherein constructing the generator matrix (105) from the ordering determined by the MRB-like basis (103) using GE performed on the submatrix of the first matrix (104) comprises:
defining a second matrix
$${G}_{1}^{2}$$
by performing GE on a submatrix of the first matrix G₁ (104);
defining a second permutation function λ₂ by performing one or more column permutations on the second matrix
$${G}_{1}^{2}$$
to bring |B_{K,LR}| columns of
$${G}_{1}^{2}$$
to first |B_{K,LR}| positions, and performing one or more row permutations on
$${G}_{1}^{2}$$
to form an identity matrix in the first |B_{K,LR}| positions; and
constructing the generator matrix (105) as the permuted second matrix
$${G}_{1}^{2} .$$

20. A computer program product comprising a program code for carrying out, when implemented on a processor, the method (1000) for performing most reliable basis-like, MRB-like, decoding of a code having length N and dimension K according to the following is performed:
receive a sequence y (101) of one or more channel observations;
order one or more reliability values (102) in a decreasing order, each reliability value (102) corresponding to the channel observations of the received sequence y (101);
determine a MRB-like basis (103) of the code based on the ordered reliability values (102), wherein the MRB-like basis (103) is defined by K independent positions that are obtained from the ordering;
construct a generator matrix (105) from an ordering determined by the MRB-like basis (103) using Gaussian elimination, GE, performed on a submatrix of a first matrix (104), the first matrix (104) being derived from a reduced echelon form generator matrix of the code; and
perform decoding (106) based on the constructed generator matrix (105).
